(19) United States
(12) Patent Application Publication
(10) Pub. No.: US 2024/0403939 A1
(43) Pub. Date: Dec. 5, 2024

(54) SERVICE PLATFORM USING NATURAL LANGUAGE FOR COMMUNICATION

(71) Applicant: An-Chi CHANG, New Taipei City (TW)

(72) Inventor: An-Chi CHANG, New Taipei City (TW)

(21) Appl. No.: 18/677,943

(22) Filed: May 30, 2024

(30) Foreign Application Priority Data
Jun. 1, 2023 (TW) 112120564

(51) Int. Cl. G06Q 30/0601; G06F 40/35; G06Q 30/0241

(52) U.S. Cl. CPC G06Q 30/0631; G06F 40/35; G06Q 30/0241

(57) ABSTRACT

A service platform using natural language for communication includes a request module, a natural language communication system and a product/service module. The request module is provided for a user to make a request in natural language. After receiving a request from a user, the natural language communication system converts and analyzes the request to obtain an analysis result. The product/service module provides a corresponding product or service according to the analysis result.

### BACKGROUND OF THE DISCLOSURE

### Technical Field

The present disclosure relates in general to a service platform, and more particularly, to a service platform using natural language for communication.

### Description of the Related Art

In Prior Art 1 which relates to the discovery and response of chatbots, a representative embodiment of Prior Art 1 discloses a mechanism for discovering, synthesizing, presenting, and interacting with a plurality of chatbots, where an agent system interacts with users and receives queries delivered to a search engine, search results are evaluated against bots provided by the domain, and queries are submitted to the discovered bots. For domain without any bot provided, a bot can be synthesized, if needed, and the queries are submitted to the synthesized bot to retrieve answers from the bot. Answers are presented directly to the bot which is displayed directly to the user in the search results page. For bots that do not display directly to the user and are presented through an agent bot, the answer can be fused. Answers from one bot can be fed back to other bots so that all of these bots can participate in group chats between bots and users.

The technological field of the Prior Art 1 is different from that of the present disclosure, which uses a mechanism for discovering, synthesizing, presenting, and interacting with a plurality of chatbots, and this system interacts with users through a broker system that receives user queries and passes them on to a search engine. Search results are evaluated based on the domain that provides the bots. For domains that do not provide bots, a bot can be synthesized on demand and queries can be submitted. Answers from the bots can be displayed directly to users on the search results page, or for bots that are not directly displayed to users, and the answers can be fused with a broker bot. Answers from a single bot can also be provided to other bots, allowing a plurality of multiple bots to participate in group chats between users and bots.

In Prior Art 2, which relates to a computational architecture of a plurality of search bots and behavioral bots and related equipment and methods, the quantity and variety of data generated in the Prior Art 2 becomes too extreme for many computing systems to handle, and it is more difficult for information systems to provide relevant data to users. Therefore, a distributed computing system is provided, and it includes server machines that form a data support platform. The platform consists of a plurality of data collectors that stream data through message buses to streaming analytics and machine learning engines; data lakes and massive indexing repositories for corresponding storage and indexing of data; behavior analysis and machine learning modules; and a plurality of application programming interfaces (APIs) to interact with the data lakes and massive indexing repositories and to interact with a plurality of applications. The applications are command cards, and each command card includes, at a minimum, command modules, memory modules, search bots, and behavioral bots that operate within the data-enabling platform.

The technical field of Prior Art 2 differs from that of the present disclosure and describes a distributed computing system for managing and processing a large amount of data and providing a data enablement platform. The platform includes: a plurality of data collectors that stream data through a message bus to a streaming analytics and machine learning engine; a data lake and a massive indexing repository for storing and indexing data; a behavioral analysis and machine learning module; and a plurality of application programming interfaces (APIs) for interacting with the data lake and the massive indexing repository and the plurality of applications. These applications are command cards, each of which consists of a command module, a memory module, search bots, and behavioral bots that run at least within the data-enabled platform.

In Prior Art 3, which relates to a natural language processing system and method, and describes an embodiment of the system that receives a request from a remote system, wherein the request includes textual data or voice data. The system analyzes the textual data or the voice data to determine the intent associated with the request. Based on the intent associated with the request, the system generates a response to the request and transmits the response to a remote system.

The technical field of the Prior Art 3 is similar to that of the present disclosure and it describes a natural language processing system and method. In an embodiment, the system receives a request from a remote system containing either textual data or voice data. The system analyzes the textual data or the voice data to determine the intent associated with the request. Based on the intent associated with the request, the system generates a response to the request and sends the response to the remote system.

In view of the deficiencies of the related arts above, how to provide a service platform using natural language for communication in order to realize the bot-to-bot natural language communications is an issue demands immediate attention and feasible solutions for the related industry.

### SUMMARY OF THE DISCLOSURE

To overcome the deficiencies of the related art, it is a primary objective of the present disclosure to provide a service platform using natural language for communication, and the service platform includes a request module, a natural language communication system and a product/service module. The request module is provided for a user to make a request in natural language. After the natural language communication system receives the request from the user, the request is converted and analyzed to obtain an analysis result. The product/service module provides a corresponding product or service according to the analysis result.

To achieve the aforementioned objective, the present disclosure provides a service platform using natural language for communication, which includes a natural language communication system with a natural language processing and transmission module and a natural language semantic construction module, and the natural language processing and transmission module is provided for transmitting messages between a request module and a product/service module, and the natural language semantic construction module is provided for retrieving a language model from a request in natural language.

To achieve the aforementioned objective, the present disclosure provides a service platform using natural language for communication, which includes a natural language processing and transmission module with a natural language receiving module, a conversion content conversion module and a semantic determination and feedback module, where the natural language receiving module is provided for receiving a request, the conversion content conversion module is provided for performing a specific conversion of the request based on an AI language model, and the semantic determination and feedback module is provided for determining whether or not the converted request needs supplementary information and feed the determination back to the request module or the product/service module.

To achieve the aforementioned objective, the present disclosure provides a service platform using natural language for communication, which includes a natural language processing and transmission module further including a semantic overlay module, a language vocabulary conversion module and a transmission model, where the semantic overlay module is provided for performing a semantic overlay of the request, the language vocabulary conversion module is provided for converting the natural language text into the language text used by the bot, and the transmission model is provided for transmitting an analysis result obtained after the request conversion and analysis to the request module or the product/service module.

To achieve the aforementioned objective, the present disclosure provides a service platform using natural language for communication, which includes a natural language semantic construction module further including a requester classification and labeling module, a product/service provider classification and labeling module and a special term lexicon language model, where the requester classification and labeling module is provided for classifying and labeling the information obtained from the request module, the product/service provider classification and labeling module is provided for classifying and labeling the product/service provided by the product/service module, and the special term lexicon language model is provided for supplementing and interpreting the special terms used in the product/service provided by the product/service module.

To achieve the aforementioned objective, the present disclosure provides a service platform using natural language for communication with a natural language communication system further including an emotion sensing and computing module, and the emotion sensing and computing module further includes an emotion sensing module and an emotion index algorithm.

To achieve the aforementioned objective, the present disclosure provides a service platform using natural language for communication with a natural language communication system which includes a transaction completion feedback module, and the transaction completion feedback module further includes a user transaction feedback and comment module and a conversion semantic analysis and emotion evaluation algorithm.

To achieve the aforementioned objective, the present disclosure provides a service platform using natural language for communication with a natural language communication system which includes a recommendation ranking module, and the recommendation ranking module further includes a recommendation ranking algorithm and a semantic knowledge graph module.

To achieve the aforementioned objective, the present disclosure provides a service platform using natural language for communication with a natural language communication system which includes an advertising module, and the advertising module further includes an advertising setting module and an advertising management and evaluation module.

To achieve the aforementioned objective, the present disclosure provides a service platform using natural language for communication with a natural language communication system which includes an external platform integration module for providing integration with an external system.

To achieve the aforementioned objective, the present disclosure provides a service platform using natural language for communication with a natural language communication system which includes a platform transaction calculation and pricing module, and the platform transaction calculation and pricing module further includes a platform transaction basic calculation algorithm and a fee calculation module.

To achieve the aforementioned objective, the present disclosure provides a service platform using natural language for communication with a natural language communication system which includes a cash flow module for providing a plurality of cash flow processing methods.

Another objective of the present disclosure is to provide an operating method of a service platform using natural language for communication, and the method includes the following steps:

Provide a request module for the use by a user to make a request in natural language.

Provide a natural language communication system, which converts and analyzes the request to obtain an analysis result after the natural language communication system receives a request from a user.

Provide a product/service module, which provides a corresponding product or service according to the analysis result.

To achieve the aforementioned objective, the present disclosure provides an operating method of a service platform using natural language for communication with a natural language communication system which includes a natural language processing and transmission module and a natural language semantic construction module, where the natural language processing and transmission module is provided for transmitting messages between a request module and a product/service module, the natural language semantic construction module is provided for retrieving a language model from a request in natural language.

To achieve the aforementioned objective, the present disclosure provides an operating method of a service platform using natural language for communication with a natural language processing and transmission module, which includes a natural language receiving module, a conversion content conversion module and a semantic determination and feedback module, where the natural language receiving module is provided for receiving a request, the conversion content conversion module is provided for performing a specific conversion of the request based on an AI language model, and the semantic determination and feedback module is provided for determining whether or not the converted request needs supplementary information and feed the determination back to the request module or the product/service module.

To achieve the aforementioned objective, the present disclosure provides an operating method of a service platform using natural language for communication with a natural language processing and transmission module further including a semantic overlay module, a language vocabulary conversion module and a transmission model, where the semantic overlay module is provided for performing a semantic overlay of a request, the language vocabulary conversion module is provided for converting the natural language text into the language text used by the bot, the transmission model is provided for transmitting the analysis result obtained after converting and analyzing the request to the request module or the product/service module.

To achieve the aforementioned objective, the present disclosure provides an operating method of a service platform using natural language for communication with a natural language semantic construction module comprises a requester classification and labeling module, a product/service provider classification and labeling module and a special term lexicon language model, where the requester classification and labeling module is provided for classifying and labeling the information obtained from the request module, the product/service provider classification and labeling module is provided for classifying and labeling the product/service provided by the product/service module and the special term lexicon language model is provided for supplementing and interpreting the special terms used in the product/service provided by the product/service module.

To achieve the aforementioned objective, the present disclosure provides an operating method of a service platform using natural language for communication with a natural language communication system which includes an emotion sensing and computing module, and the emotion sensing and computing module further includes an emotion sensing module and an emotion index algorithm.

To achieve the aforementioned objective, the present disclosure provides an operating method of a service platform using natural language for communication with a natural language communication system which includes a transaction completion feedback module, and the transaction completion feedback module further includes a user transaction feedback and comment module and a conversion semantic analysis and emotion evaluation algorithm.

To achieve the aforementioned objective, the present disclosure provides an operating method of a service platform using natural language for communication with a natural language communication system which includes a recommendation ranking module, and the recommendation ranking module further includes a recommendation ranking algorithm and a semantic knowledge graph module.

To achieve the aforementioned objective, the present disclosure provides an operating method of a service platform using natural language for communication with a natural language communication system which includes an advertising module, and the advertising module further includes an advertising setting module and an advertising management and evaluation module.

To achieve the aforementioned objective, the present disclosure provides an operating method of a service platform using natural language for communication with a natural language communication system which includes an external platform integration module for providing integration with an external system.

To achieve the aforementioned objective, the present disclosure provides an operating method of a service platform using natural language for communication with a natural language communication system which includes a platform transaction calculation and pricing module, and the platform transaction calculation and pricing module further includes a platform transaction basic calculation algorithm and a fee calculation module.

To achieve the aforementioned objective, the present disclosure provides an operating method of a service platform using natural language for communication with a natural language communication system which includes a cash flow module for providing a plurality of cash flow processing methods.

### BRIEF DESCRIPTION OF THE DRAWINGS

FIG. 1 is a schematic block diagram of a service platform using natural language for communication in accordance with the present disclosure;

FIG. 2 is a flow chart of an operating method of a service platform using natural language for communication in accordance with the present disclosure;

FIG. 3 is a flow chart of an operation mechanism a service platform using natural language for communication in accordance with a first embodiment of the present disclosure;

FIG. 4 is a schematic block diagram of a service platform using natural language for communication in accordance with a second embodiment of the present disclosure;

FIG. 5 is a schematic diagram showing an example of the communication of a related-art Electronic Information Exchange; and

FIG. 6 is a schematic diagram showing an example of using a service platform using natural language for communication of the present disclosure.

### DESCRIPTION OF THE PREFERRED EMBODIMENTS

The objectives, technical contents and features of this disclosure will become apparent in the following detailed description of the preferred embodiments with reference to the accompanying drawings. It is noteworthy that the drawings used in the specification and subject matters of this disclosure are intended for illustrating the technical characteristics of this disclosure, but not necessarily to be drawn according to actual proportion and precise configuration. Therefore, the scope of this disclosure should not be limited to the proportion and configuration of the drawings.

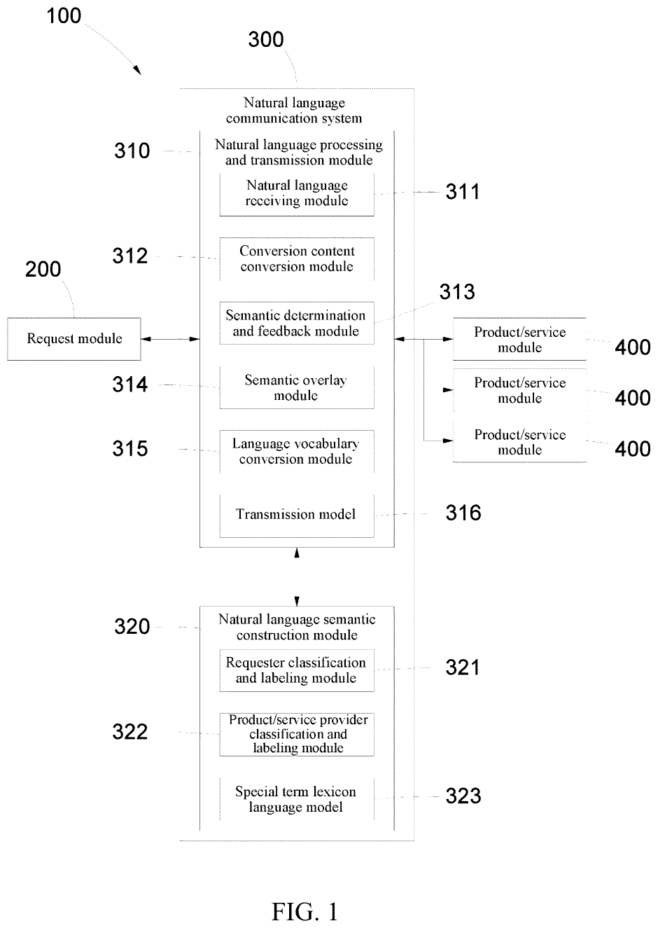

With reference to FIG. 1 for a service platform using natural language for communication 100 in accordance with the present disclosure, the service platform 100 includes a request module 200, a natural language communication system 300 and a product/service module 400. The request module 200 is provided for a user to make a request in natural language. The natural language communication system 300 is provided for converting and analyzing a request to obtain and an analysis result after receiving the request from the user. The product/service module 400 is used to provide a corresponding product or service according to the analysis result. In other words, after a user makes a request through the request module 200, the user can interact with a single or multiple product/service module 400 through the natural language communication system 300 of the present disclosure, so that the provider of the single or multiple product/service module 400 can provide the corresponding service to users.

The aforementioned user who makes the request through the request module 200 is an individual/enterprise user, and the request is made in natural language, and various types of equipment can be used as a medium to make the request. The medium includes but not limiting to transportation vehicles (such as motor vehicles), televisions, mobile phones, computers, machines and other devices and their Apps, Metaverse, Bot, and other software/virtual media.

The provider of the aforementioned single or multiple product/service modules 400 may be a product/service portal based on natural language and provided by an individual/enterprise. In addition, the media used by the provider of the single or multiple product/service module 400 to provide service includes but not limited to transportation vehicles (such as motor vehicles), televisions, mobile phones, computers, machines, and other devices and their Apps, Metaverse, Bot, and other software/virtual media, which can achieve the method of realizing bot-to-bot communication through natural language in accordance with the present disclosure.

With reference to FIG. 1 for a service platform using natural language for communication 100 of the present disclosure, the service platform 100 includes a natural language communication system 300, which further includes a natural language processing and transmission module 310 and a natural language semantic construction module 320. The natural language processing and transmission module 310 is provided for transmitting messages between the request module 200 and the product/service module 400, and the natural language semantic construction module 320 is provided for retrieving a language model from a request of natural language.

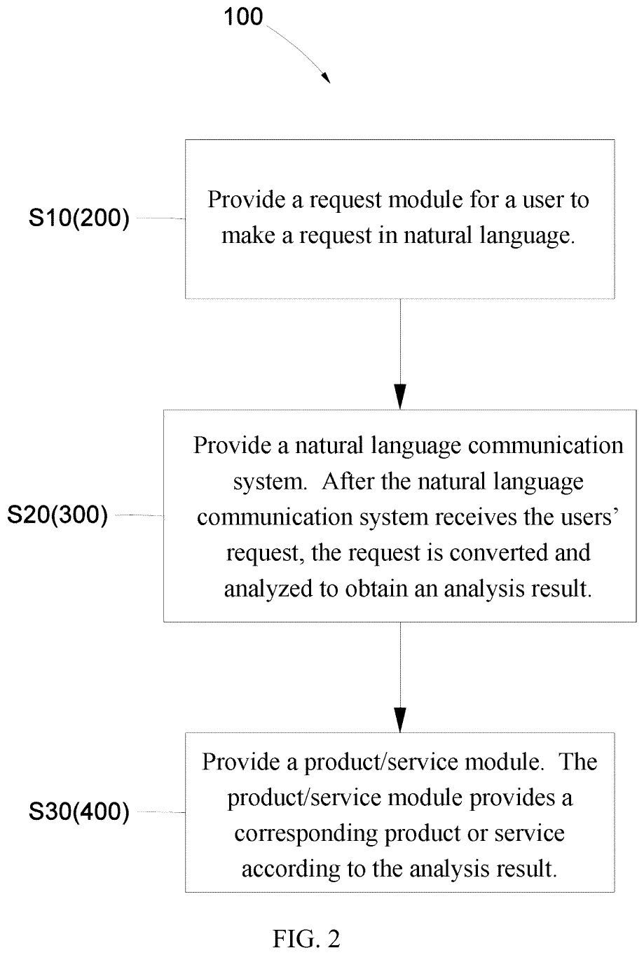

With reference to FIG. 2 for a flow chart of an operating method of a service platform using natural language for communication in accordance with the present disclosure, the method includes the following steps of: (S10) providing a request module 200 used by a user to make a request in natural language; (S20) providing a natural language communication system 300 for converting the natural language communication system after receiving the request of the user, and converting and analyzing the request to obtain an analysis result; and (S30) providing a product/service module 400 for providing a corresponding product or service according to the analysis result.

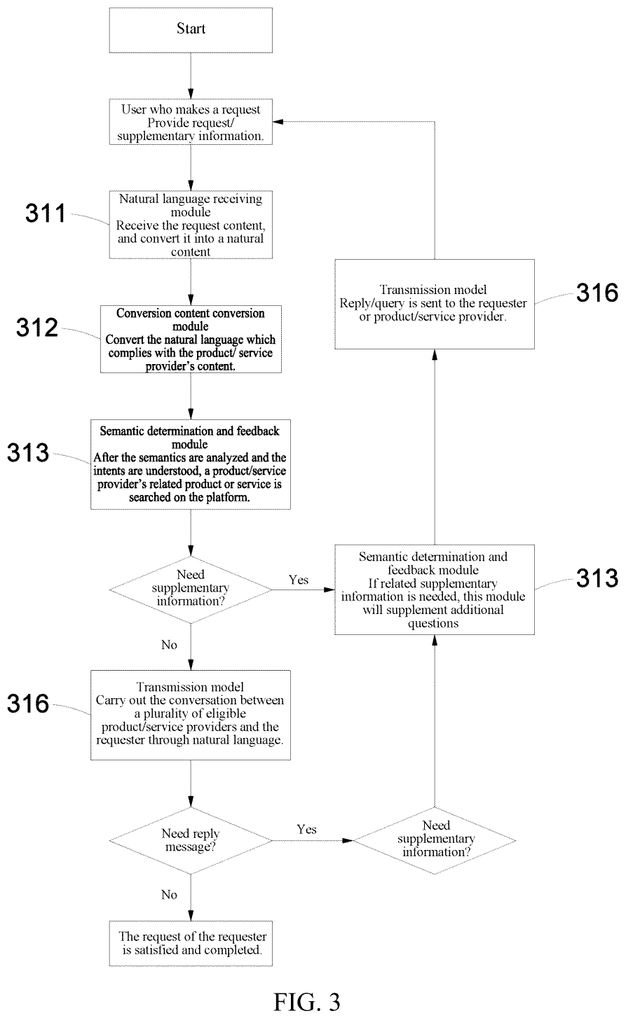

With reference to FIG. 3 for a service platform using natural language for communication 100 in accordance with an embodiment of the present disclosure, the service platform includes a natural language processing and transmission module 310 which further includes a natural language receiving module 311, a conversion content conversion module 312 and a semantic determination and feedback module 313. The natural language receiving module 311 is provided for receiving the request, the conversion content conversion module 312 is provided for performing a specific conversion of the request based on an AI language model, and the semantic determination and feedback module 313 is provided for determining whether or not the converted request needs supplementary information and feedbacks to the request module 200 or the product/service module 400.

In FIG. 1, the service platform using natural language for communication 100 in accordance with the present disclosure includes a natural language processing and transmission module 310 which further includes a semantic overlay module 314, a language vocabulary conversion module 315 and a transmission model 316. The semantic overlay module 314 is provided for performing a semantic overlay of the request, the language vocabulary conversion module 315 is provided for converting the user's intention, request, feature and fragment of text into the natural language text, which is completed by a bot in any form that can read the natural language, and the transmission model 316 is provided for transmitting the analysis result obtained after the conversion and analysis of the request to the request module 200 or the product/service module 400.

Further, natural language receiving module 311 is provided for receiving a natural language text transmitted from a front end (which is not limited to the user who makes the request or the product/service provider) and also for receiving a voice content from the front end, and converting the voice content into a natural language text through the technology including but not limited to Speech to Text.

The conversion content conversion module 312 is provided for performing a specific conversion of the conversation content by an algorithm based on an AI language model, so that the converted conversation content matches with the product/service provider; if the conversation content does not match with the service content range of the product/service provider or produces prejudicial semantics or vocabulary, the conversion content conversion module 312 will label the conversation content as a semantic tag content by AI.

The semantic determination and feedback module 313 compares the semantic tag content transmitted from the conversion content conversion module 312 through the information of the following “Characteristic Value Semantic Database”, calculates and determines whether there is a need to supplement related information, and provides feedback to the front-end (which is not limited to the requester or the product/service provider).

The semantic overlay module 314 performs a semantic overlay when the conversation content cannot be processed in one time, and the degree of relevance between the current conversation content and the previous conversation content is determined that they are continuous contents. The semantic overlay module 314 can be integrated with a feature filter algorithm module to perform feature filter algorithm after the semantic overlay is completed.

The language vocabulary conversion module 315 uses the language model to convert the input from the front end (which is not limited to the requester or the product/service provider) including user's intention, request, feature, fragment of text into a natural language text, and such text is given to a bot in any form that can read natural language, and a special term lexicon language model 323 is used to perform, compute, supplement and enhance the quality of the conversation content.

The transmission model 316 is provided for transmitting the converted natural language to the requester and the product/service provider.

The scenario “Restaurant Reservation” is taken as an example for illustrating an embodiment of the procedure as follows:

1. A requester uses a medium (such as a mobile phone app) to make a request “I'm in Xinyi District, looking for an American restaurant, but don't know which one is available?”

2. After receiving the request content, the natural language receiving module 311 converts the request content into natural language.

3. The conversion content conversion module 312 converts the natural language into a content matched with the product/service provider.

4. After analyzing the semantics and understanding the intents, the semantic determination and feedback module 313 searches for a related product or service that matches with the requester or the product/service provider on a platform.

5. If there is a need for supplementary information, the semantic determination and feedback module 313 will supplement additional questions, such as asking the requester (for example, what time and how many persons?) through the transmission module 316.

6. After the user who makes the request replies through a medium (such as a mobile phone app), the above Steps 2˜5 are carried out until there is no need to add related information, and a plurality of product/service providers that match with the conditions and the user who makes the request have a conversation in natural language through the transmission model 316.

7. The steps 2˜5 are repeated (e.g., the requester asks, “Is there a table for three at 7:30 pm?”, and the product/service provider A replies, “No, there isn't.” and the product/service provider B replies, “You need to wait till 8 for the table.”, and the product/service provider C replies, “Yes, may I help you to make the reservation?”, and finally the requester replies, “Okay, please make a reservation for me at Restaurant C.”, and the reservation information is sent to the product/service provider C), until the request is satisfied.

Finally, the request of the user who makes the request is satisfied.

Another scenario “A coffee maker IoT proactively detects when coffee beans are about to run out” is used as an example to illustrate the procedure of an embodiment as follows:

1. A coffee maker of a user who makes the request uses a medium (such as a coffee maker microchip) to make a request on “The coffee beans are about to run out, and a user likes slightly roasted coffee beans. What are the choices?”

2. After receiving the request, the natural language receiving module 311 converts the request content into natural language.

3. The conversion content conversion module 312 converts the natural language into a content that matches with the product/service provider.

4. After analyzing the semantics and understanding the intents, the semantic determination and feedback module 313 searches for a related product or service that matches the requester or the product/service provider on a platform. For example, the questions “Do you have slightly roasted coffee beans, and what is the price including the delivery cost for 3 lbs.?” are asked through the transmission model 316.

5. If it is necessary to supplement related information, the semantic determination and feedback module 313 will supplement additional questions.

6. A plurality of product/service providers and the requester who matches with the conditions have a conversation in natural language through the transmission model.

The Steps 2˜5 are repeated (For example, the product/service provider A replies, “The slightly roasted coffee beans will be available by the end of August. Is it acceptable to you?”, and the product/service provider B replies “There are several varieties including 000 and XXX of the prices (delivery cost included) of $500 and $750 respectively”, finally the user who makes the request gives an affirmative reply and place the order directly “Okay, please help me choose Item OOO from Provider B”, and finally the order is placed directly to complete the transaction), until the request is satisfied.

Finally the request of the requester is satisfied.

In an embodiment, the present disclosure uses a micro service structure as an underlying design and has the following features for information security:

1. Private network connection: It can be used to increase security. According to the request of network data transmission, for the user who makes the request, the provider of product/service module 400 including individual/enterprise may use any medium including but not limited to Mobile for data transmission between apps, web apps, enterprise software, etc. and modules.

2. Data encryption/decryption function: The encryption/decryption function of public key and private key can be used to increase security. According to the request of network data transmission, for user who makes the request, the provider of product/service module 400 including individual/enterprise may use any medium including but not limited to Mobile for data transmission between apps, web apps, enterprise software, etc. and modules.

3. Corporate compliance request: In the platform and operating method of the present disclosure, all information should meet the corporate compliance requirements including but not limited to GCPR, SOC2, etc.

In the present disclosure, the natural language semantic construction module 320 retrieves a language model for the user who makes the request or the provider of the product/service module 400, thereby clarifying the language content of each end and enhancing language recognition accuracy.

In an implementation mode, natural language semantic construction module 320 includes a requester classification and labeling module 321, a product/service provider classification and labeling module 322 and a special term lexicon language model 323. Wherein, the requester classification and labeling module 321 classifies and labels the information obtained from the request module 200, and the product/service provider classification and labeling module 322 classifies and labels the product/service provided by the product/service module 400, and the special term lexicon language model 323 is provided for supplementing and interpreting the specialized terminology in the product/service provided by the product/service module 400.

In detail, the requester classification and labeling module 321 can use AI to label based on whether the user who makes the demand is an individual or an enterprise, analyze its basic information and the conversation content generated during related transactions, labels its basic information including but not limited to preferences, family, friend, etc., understands the characteristics of the user who makes the request, and generates the classification and label of the requester.

The product/service provider classification and labeling module 322 uses AI to analyze the characteristics and labeling of the product or service provided by the product/service provider according to the item, content and introduction, and generate the classification and label of the product/service provider.

The special term lexicon language model 323 uses the specialized terminology in the product or service of the product/service provider for supplement and interpretation, and adjusts the language model of the terminology to be a supplementary base to the language model (base model).

Through the processed language content above, the results are handed over to the following algorithm and database for processing and storage, and the subsequent natural language processing and transmission module 310 is provided for conversation processing and transmission:

1. Self-training service semantic algorithm: It analyzes the features and labels of the product/service provider, and through a non-Rule-based deep learning algorithm, the service or product features of the product/service provider are analyzed, and the results of the natural language descriptions and the semantic descriptions are calculated and then stored into the feature-value semantic database. In an embodiment, there is a product/service provider, whose service is food and beverage service, and the self-training service semantic algorithm is based on the food ordering scenario, and the required basic information includes but not limiting to the number of people, dietary preference, time, location, any special restrictions, or the product/service provider's other service features.

2. Characteristic Value Semantic Database: It is a database that stores the feature labels of the product or service of the product/service provider, and the required basic semantics is provided. When a subsequent requester proposes conversation content, his request can be directly judged, and the subsequent natural language processing and transmission module 310 can make a preliminary reply. In an embodiment, in order for the requester to find a suitable restaurant, the subsequent natural language processing and transmission module 310 can provide basic information required for restaurant service including but not limited to the number of people, food preferences, time, location, whether there are special restrictions based on the “Characteristic Value Semantic Database”, and the requester is asked to supplement related information through the semantic determination and feedback module 313.

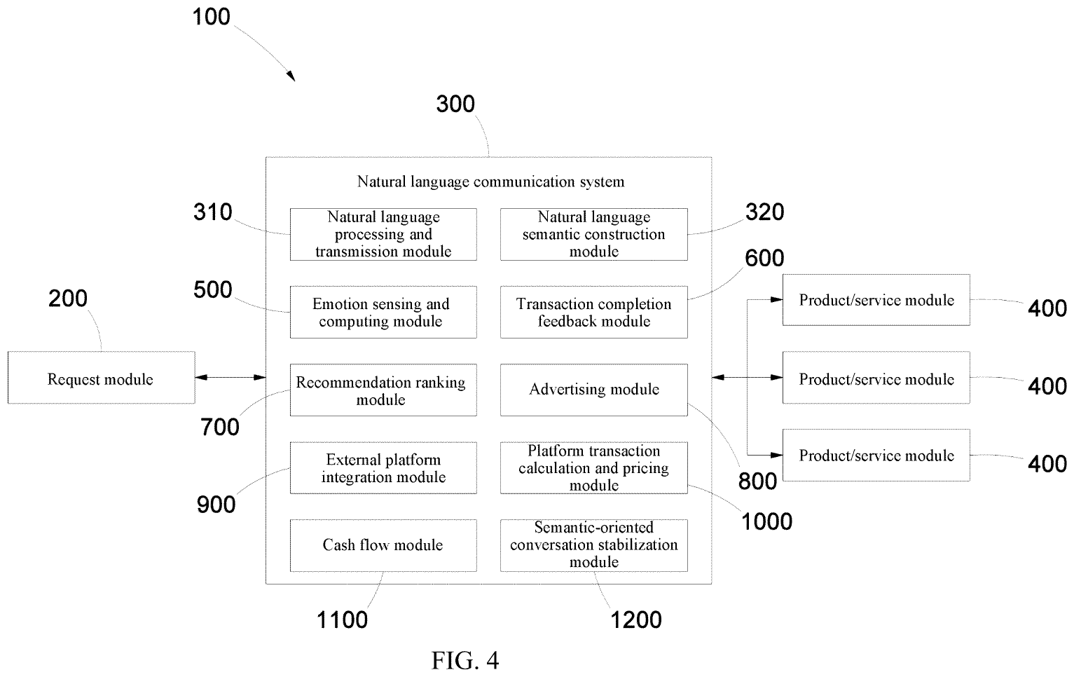

In FIG. 4, the service platform using natural language for communication 100 of the present disclosure can further add the following additional modules, thereby increasing functionality and establishing a platform-based solution. Each of the following modules can be connected to the natural language processing and transmission, the module 310 and the natural language semantic construction module 320, and these additional modules include but not limited to:

### I. Emotion Sensing and Computing Module

The emotion sensing and computing module 500 senses the emotional state of people (such as the user who makes the request) through a conversation content (for example, the user who makes the request may start to complain about something). The emotion sensing and computing module 500 will record the conversation content and review the unsatisfactory reply, negative vocabulary and other contents, and perform a content elimination action (for example, a specific store that has been mentioned many times as negative vocabulary by the requester will be eliminated). The emotion sensing and computing module 500 includes the following models and algorithms:

1. Emotion sensing module: It obtains an emotional feeling index from the conversation content through the language model.

2. Emotion index algorithm: It computes the emotional change in the emotional perception indicator and the overall conversation content to capture the emotional change of the conversation, product, and service to people (such as user who makes the request), and records them for the use in the recommended optimization of the following recommendation ranking module 700, and improving the semantic determination and feedback module 313, feature filter calculation module, recommended optimization algorithm, etc.

### II. Transaction Completion Feedback Module

The transaction completion feedback module 600 integrates the collection of feedback information and emotion index after the completion of conversation content or the transaction. The transaction completion feedback module 600 includes the following modules and algorithms:

1. User transaction feedback and comment module: It collects the requester's feelings, comments and whether it is a recommended index through questions after the whole conversation is ended or the transaction is completed.

2. Conversion semantic analysis and emotion evaluation algorithm: It continues to analyze the semantic emotions of both the requester and the product/service provider, and records the emotion index in the record of the product/service provider at the same time, during the process of the whole conversation. In the records, the recommendation ranking of the following recommendation ranking module 700 is provided.

### III. Recommendation Ranking Module

The recommendation ranking module 700 is provided for computing the recommendation ranking of the product/service providers. The recommendation ranking module 700 includes the following modules and algorithms:

1. Recommendation ranking algorithm: It is based on the requester's classification and label generated by the requester classification and labeling module 321, the product/service provider's classification and label generated by the product/service provider classification and labeling module 322, and the conversion content generated by the conversion module 312 to combine the semantic label content with historical data of the same classification and label of the requester, and the historical data of the same classification and label of the product/service provider, and calculate the recommended overall rating score based on the past transaction rating score of the transactions completed within the same transaction completion feedback module 600 as mentioned above, and the emotional feeling index in the emotion sensing and computing module 500, and the accumulative score of the advertising module 800 mentioned later, and generate the recommendation ranking content based on its overall rating score, and then the recommendation ranking content can be presented according to the sematic content through the conversation content of the semantic determination and feedback module 313 and the advertising module 800.

2. Semantic knowledge graph module: It establishes a knowledge graph for continuous optimization of recommendation ranking algorithm based on the conversation content of each time, and the feedback content of the product/service provider, and the product and service request and content of the product/service provider.

### VI. Advertising Module

The advertising module 800 is a means provided for the product/service provider to integrate the later-described product/service provider's cash flow module 1100 to pay for advertising investment, and provides advertising investment that affects the recommendation ranking content of the aforementioned recommendation ranking module 700. The advertising module 800 includes the following modules and algorithms:

1. Advertising setting module: The product/service provider can conduct advertising investment in the advertising module 800 for its product, service or product/service or its own brand, which affect the recommendation ranking content: The embodiment of advertising investment is divided into different investing modes according to the dollar amount, including but not limited to successfully matched investments, overall recommendation ranking investment, total budget limit investment, etc., and the advertising module 800 will use different algorithms to affect the recommendation ranking content according to different contents and dollar amounts of the investment.

2. Advertising management and evaluation module: The product/service provider performs advertising benefit inquiry during or after the advertising setting process of advertising module 800. The advertising module 800 provides related reports to analyze advertising investment targets, and the benefits generated: Before the execution of the advertising investment is completed, the advertising investment can be suspended or adjusted in advertising module 800.

### V. External Platform Integration Module

The external platform integration module 900 provides an integration function of the external platform, including but not limited to Google Map, Apple Map and other graphics and recommendation information, and a market platform including but not limited to iCHEF, inline, etc., so that the present disclosure has the ability to integrate terminal devices or applications on these platforms.

### VI. Platform Transaction Calculation and Pricing Module

The platform transaction calculation and pricing module 1000 provides the calculation of transactions and fees based on the attributes of the user who makes the request and the product/service provider. The platform transaction calculation and pricing module 1000 includes the following algorithms:

1. Platform transaction basic calculation algorithm: It provides transaction calculation based on the attributes of the user who makes the request and the product/service provider. The transaction calculation method includes but not limited to the number of transactions, the number of chat words, and the transaction type, etc.

2. Fee calculation module: Based on the attributes of the user who makes the request and the product/service provider, the basic calculation results of the aforementioned platform transaction basic calculation algorithm are brought in for fee calculation. The fee calculation method includes but not limited to unit price based on the number of times unit price based on the number of chat words, step-by-step pricing, agreed calculation method, pricing based on transaction fee ratio, free of charge, etc.

### VII. Cash Flow Module

The cash flow module 1100 provides a plurality of cash flow processing models, including but not limited to an integrated payment function with a cash flow platform, issuance of invoices and receipts, generation of billing statements, delivery of remittance checks, and inquiries of cash flow data and also provides other functions such as the utilization of cash flow services of the present disclosure, and the advertising investment payment method of the advertising module 800.

### VIII. Semantic-Oriented Conversation Stabilization Module

The semantic-oriented conversation stabilization module 1200 ensures the bot-to-bot consistency on topics understood by natural language, and detects/identifies whether the conversation begins to deviate from the preset topic, and provides immediate correction and guidance, and this module includes the following systems:

Conversation deviation sensing system: It cooperates with the “semantic determination and feedback module 313” and the “special term lexicon language model 323” for conversation content. In the process of analyzing semantics and understand intents every time, sensing the change of intent of the conversation and whether it begins to deviate from the original main axis of the conversation, and for the conversation where the intent changes, the “conversation summary guidance system” described later is triggered to process the conversation and return it to the original intent.

Conversation summary guidance system: It aims at a conversation for which the “conversation deviation sensing system” is notified that the intent has changed, and the entire conversation content is summarized and analyzed again by the “semantic determination and feedback module 313” to analyze the semantics and understand the intents according to the confirmed conversation intent, and use the “transmission module 316” to convert the intent into natural language, pass it to the requester and the product/service provider, and complete conversation intent correction.

Compared with the related art, where the Electronic Information Exchange (EDI) relied upon in the past for communication between enterprise and enterprise, equipment and equipment, machine and machine, system and inter-system, or across different systems and equipment, and specific data exchange format (API), the present disclosure provides an innovative communication method. FIG. 4 shows an example of EDI communications.

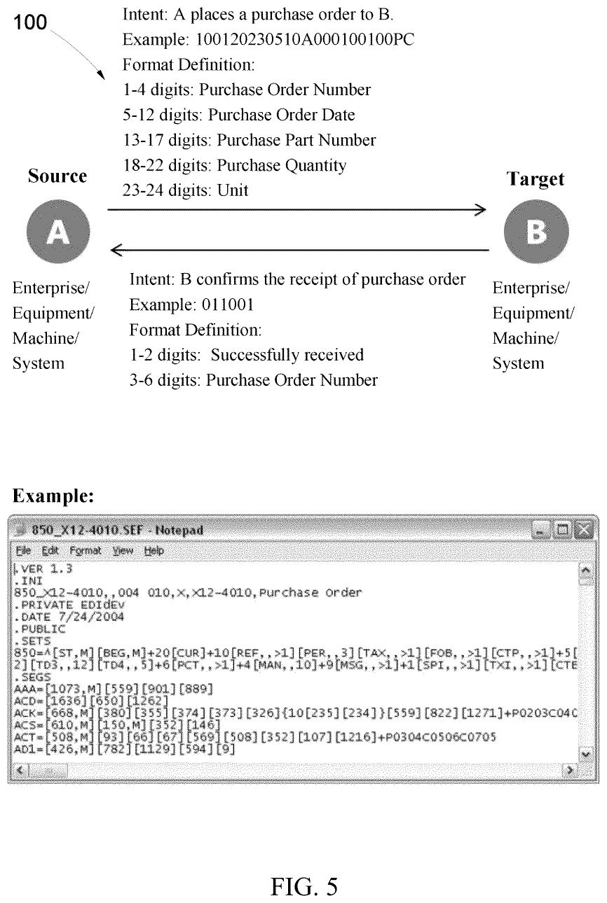

In FIG. 5, the use of EDI obviously faces multiple challenges, including the need for both communicating parties to define identifiable formats and content meanings to correctly transmit information, and the source end needs to define different formats when corresponding to different target objects, etc., thus increasing the time and burden of the processing.

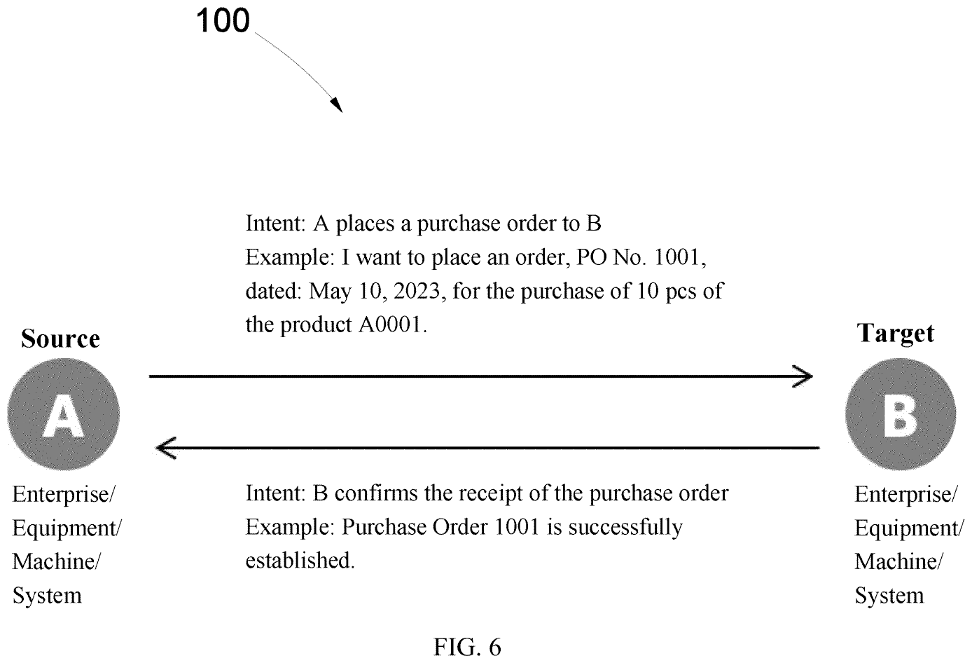

On the contrary, as shown in FIG. 6, the present disclosure realizes all communications between non-human entities through natural language by using AI/language model.

In summation of the description above, the main characteristics and advantages of the service platform using natural language for communication of the present disclosure are as follows:

1. Industrial applicability:

The present disclosure can be applied to various industries that require electronic data interchange. By using natural language instead of traditional EDI, it accelerates the application and automation of electronic data interchange.

2. Novelty:

Related arts require both parties to have a pre-defined transmission format and standardized content. However, the present disclosure uses natural language as the transmission format which is fault-tolerant. Even if the sentence combinations are different, as long as the semantics are the same, the data exchange can be completed correctly.

In this way, the present disclosure does not need the stipulation of formats in advance, and communication can be achieved even if the languages used by the source end and the receiving end are different (for example, English is used by one end and Chinese is used by the other end).

3. Inventiveness

The present disclosure converts source information into natural language through the language model, and then transmits it to the receiving end. The receiving end uses the comprehension and summarization capabilities of the language model to complete the understanding of the required content and subsequent processing procedures.

The present disclosure can automatically obtain the introduction content of the product or service item through the basic information records including but not limited to company name, address, contact information, etc. of the product/service provider, and the API network location for receiving inputs in natural language, thereby simplifying the collection of information and enhancing immediacy.

The present disclosure can classify and label various product/service providers, establish a market mechanism for product/service providers, and recommend other additional or follow-up services of the product/service providers (such as advertising module), and at the same time records the context of natural language to define target services that are more in line with user expectations through algorithms.

The present disclosure can avoid the problem of ineffective communication between generative AI of the related art through the special term lexicon language model 323, which includes specialized terminology in different products or services, and Characteristic Value Semantic Database. Basic information including but not limited to the number of people, food preferences, time, location, special restrictions and other basic content is adopted to avoid ineffective communication.

The present disclosure uses the “semantic-oriented conversation stabilization module 1200” to overcome the problem of having a high probability of the conversation deviating from the original topic (e.g., ordering food, finding a clinic, etc.) in Bot to Bot communication through natural language due to the characteristics of the existing language model generating text in the natural language will lead to a deviation of comprehension of the conversation during the stages of understanding the natural language and making replies in each conversation. Therefore, the module can use the “conversation deviation sensing system” to detect conversation deviation when replying to the bot of the product/service provider. If the conversation intent deviates, the “conversation summary guidance system” will be triggered to intervene and analyze the entire conversation process again, confirm the consistency of the original intent, and use “semantic determination and feedback module” and “special term lexicon language model” to guide the conversation back on track to ensure that the conversation can return to the correct intent in order to complete the transaction successfully.

The above embodiments are provided for the purpose of illustrating the ideas and technical characteristics of the present disclosure and enabling people having ordinary skill in the art to understand the content of the present disclosure and implement it accordingly. However, numerous modifications and variations could be made thereto without departing from the scope and spirit of the disclosure set forth in the claims.

What is claimed is:

1. A service platform using natural language for communication, comprising:
a request module, provided for a user to make a request in a natural language;
a natural language communication system, for receiving the request of the user and then converting and analyzing the request to obtain an analysis result; and
a product/service module, for providing a corresponding product or service according to the analysis result.

2. The service platform using natural language for communication according to claim 1, wherein the natural language communication system comprises a natural language processing and transmission module and a natural language semantic construction module, the natural language processing and transmission module is provided for transmitting messages between the request module and the product/service module, and the natural language semantic construction module is provided for retrieving a language model through the request in the natural language.

3. The service platform using natural language for communication according to claim 2, wherein the natural language processing and transmission module comprises a natural language receiving module, a conversion content conversion module and a semantic determination and feedback module, the natural language receiving module is provided for receiving the request, the conversion content conversion module is provided for performing a specific conversion of the request based on an AI language model, and the semantic determination and feedback module is provided for determining whether or not the converted request needs supplementary information and feeds it back to the request module or the product/service module.

4. The service platform using natural language for communication according to claim 3, wherein the natural language processing and transmission module further comprises a semantic overlay module, a language vocabulary conversion module and a transmission model, the semantic overlay module is provided for performing a semantic overlay of the request, the language vocabulary conversion module is provided for converting the user's intention, request, feature and fragment of text into the natural language text, which is completed by a bot in any form that can read the natural language, and the transmission model is provided for transmitting the analysis result obtained after the conversion and analysis of the request to the request module or the product/service module.

5. The service platform using natural language for communication according to claim 4, wherein the natural language semantic construction module comprises a requester classification and labeling module, a product/service provider classification and labeling module and a special term lexicon language model, the requester classification and labeling module is provided for classifying and labeling the information obtained by the request module, the product/service provider classification and labeling module is provided for classifying and labeling the product/service provided by the product/service module, and the special term lexicon language model is provided for supplementing and interpreting the specialized terminology used in the product/service provided by the product/service module.

6. The service platform using natural language for communication according to claim 5, wherein the natural language communication system comprises an emotion sensing and computing module, and the emotion sensing and computing module further comprises an emotion sensing module and an emotion index algorithm.

7. The service platform using natural language for communication according to claim 5, wherein the natural language communication system comprises a transaction completion feedback module, and the transaction completion feedback module further comprises a user transaction feedback and comment module and a conversion semantic analysis and emotion evaluation algorithm.

8. The service platform using natural language for communication according to claim 5, wherein the natural language communication system comprises a recommendation ranking module, and the recommendation ranking module further comprises a recommendation ranking algorithm and a semantic knowledge graph module.

9. The service platform using natural language for communication according to claim 5, wherein the natural language communication system comprises an advertising module, and the advertising module further comprises an advertising setting module and an advertising management and evaluation module.

10. The service platform using natural language for communication according to claim 5, wherein the natural language communication system comprises an external platform integration module, and the external platform integration module is provided to be integrated with an external system.

11. The service platform using natural language for communication according to claim 5, wherein the natural language communication system comprises a semantic-oriented conversation stabilization module, the semantic-oriented conversation stabilization module is provided for ensuring the bot-to-bot consistency on topics understood by natural language and detecting/identifying whether the conversation begins to deviate from the preset topic, and providing immediate correction and guidance; the semantic-oriented conversation stabilization module comprises a conversation deviation sensing system and a conversation summary guidance system.

12. The service platform using natural language for communication according to claim 11, wherein the conversation deviation sensing system of the semantic-oriented conversation stabilization module cooperates with the semantic determination and feedback module and the special term lexicon language model to sense the change in intention of the conversation and whether it begins to deviate from the original main axis of the conversation during the process of analyzing the semantics and understanding the intents of the conversation content for each time, and for conversations where the intent changes, the conversation summary guidance system is triggered to process the conversation and return to the original intent of the conversation; the conversation summary guidance system is provided for summarizing the entire conversation content that is noticed by the conversation deviation sensing system to be a conversation with a change of intent, and then the semantic determination and feedback module analyzes the semantics and understands the intents again, and the transmission module transmits the intent which is converted into natural language according to the confirmed conversation intent to the requester, and the product/service provider, so as to complete a conversation intent correction.

13. An operating method of a service platform using natural language for communication, comprising the steps of:
providing a request module, used by a user to make a request in a natural language;
providing a natural language communication system, for converting the natural language communication system after receiving the request of the user, and converting and analyzing the request to obtain an analysis result; and
providing a product/service module, for providing a corresponding product or service according to the analysis result.

14. The operating method of a service platform using natural language for communication according to claim 13, wherein the natural language communication system comprises a natural language processing and transmission module and a natural language semantic construction module, the natural language processing and transmission module is provided for transmitting messages between the request module and the product/service module, and the natural language semantic construction module is provided for retrieving a language model through the request in the natural language.

15. The operating method of a service platform using natural language for communication according to claim 14, wherein the natural language processing and transmission module comprises a natural language receiving module, a conversion content conversion module and a semantic determination and feedback module, the natural language receiving module is provided for receiving the request, the conversion content conversion module is provided for performing a specific conversion of the request based on an AI language model, and the semantic determination and feedback module is provided for determining whether or not the converted request needs to supplement information and feeds it back to the request module or the product/service module.

16. The operating method of a service platform using natural language for communication according to claim 15, wherein the natural language processing and transmission module further comprises a semantic overlay module, a language vocabulary conversion module and a transmission model, the semantic overlay module is provided for performing a semantic overlay of the request, the language vocabulary conversion module is provided for converting the user's intention, request, feature and fragment of text into the natural language text, which is completed by a bot in any form that can read the natural language, and the transmission model is provided for transmitting the analysis result obtained after the conversion and analysis of the request to the request module or the product/service module.

17. The operating method of a service platform using natural language for communication according to claim 16, wherein the natural language semantic construction module comprises a requester classification and labeling module, a product/service provider classification and labeling module and a special term lexicon language model, the requester classification and labeling module is provided for classifying and labeling the information obtained by the request module, the product/service provider classification and labeling module is provided for classifying and labeling the product/service provided by the product/service module, and the special term lexicon language model is provided for supplementing and interpreting the specialized terminology used in the product/service provided by the product/service module.

18. The operating method of a service platform using natural language for communication according to claim 17, wherein the natural language communication system comprises an emotion sensing and computing module, and the emotion sensing and computing module further comprises an emotion sensing module and an emotion index algorithm.

19. The operating method of a service platform using natural language for communication according to claim 17, wherein the natural language communication system comprises a transaction completion feedback module, and the transaction completion feedback module further comprises a user transaction feedback and comment module and a conversion semantic analysis and emotion evaluation algorithm.

20. The operating method of a service platform using natural language for communication according to claim 17, wherein the natural language communication system comprises a recommendation ranking module, and the recommendation ranking module further comprises a recommendation ranking algorithm and a semantic knowledge graph module.

21. The operating method of a service platform using natural language for communication according to claim 17, wherein the natural language communication system comprises an advertising module and the advertising module further comprises an advertising setting module and an advertising management and evaluation module.

22. The operating method of a service platform using natural language for communication according to claim 17, wherein the natural language communication system comprises an external platform integration module, and the external platform integration module is provided to be integrated with an external system.

23. The operating method of a service platform using natural language for communication according to claim 17, wherein the natural language communication system comprises a semantic-oriented conversation stabilization module, the semantic-oriented conversation stabilization module is provided for ensuring the bot-to-bot consistency on topics understood by natural language, and detecting/identifying whether the conversation begins to deviate from the preset topic, and providing immediate correction and guidance; the semantic-oriented conversation stabilization module comprises a conversation deviation sensing system and a conversation summary guidance system.

24. The operating method of a service platform using natural language for communication according to claim 23, wherein the conversation deviation sensing system of the semantic-oriented conversation stabilization module cooperates with the semantic determination and feedback module and the special term lexicon language model to sense the change in intention of the conversation and whether it begins to deviate from the original main axis of the conversation during the process of analyzing the semantics and understanding the intents of the conversation content for each time, and for conversations where the intent changes, the conversation summary guidance system is triggered to process the conversation and return to the original intent of the conversation; the conversation summary guidance system is provided for summarizing the entire conversation content that is noticed by the conversation deviation sensing system to be a conversation with a change of intent, and then the semantic determination and feedback module analyzes the semantics and understands the intents again, and the transmission module transmits the intent which is converted into natural language according to the confirmed conversation intent to the requester, and the product/service provider, so as to complete a conversation intent correction.
